(19) United States
(12) Patent Application Publication
(10) Pub. No.: US 2021/0304284 A1
(43) Pub. Date: Sep. 30, 2021

(54) DETERMINING USER SPENDING PROPENSITIES FOR SMART RECOMMENDATIONS

(71) Applicant: Intuit Inc., Mountain View, CA (US)

(72) Inventors: Daniel Ben David, Hod Hasharon (IL); Yehezkel Shraga Resheff, Jerusalem (IL); Nirmala Ranganathan, Saratoga, CA (US); Yair Horesh, Kfar Sava (IL)

(73) Assignee: Intuit Inc., Mountain View, CA (US)

(21) Appl. No.: 16/836,305

(22) Filed: Mar. 31, 2020

(51) Int. Cl. G06Q 30/06; G06Q 40/02; G06N 20/00; G06N 5/04; G06F 40/30

(52) U.S. Cl. CPC G06Q 30/0631; G06Q 40/02; G06F 40/30; G06N 5/04; G06N 20/00

(57) ABSTRACT

A method may include obtaining, over a network from a financial institution and using login credentials of a user, transactions corresponding to the user, calculating average transaction amounts for merchants based on the transactions, generating a spending propensity score for a category using a harmonic mean of amounts in a subset of the transactions corresponding to the category, generating, for the category, spending match scores between the spending propensity score and the average transaction amounts for the merchants, and recommending a merchant to the user using the spending match scores.

### BACKGROUND

Systems for generating financial recommendations typically leverage a model of the customer. For example, a financial recommendation may suggest a product to purchase or a merchant with whom to transact business. One aspect of the customer model is the customer's propensity to spend, which is typically based on the amounts spent in customer transactions. However, such approaches fail to capture the deeper, contextual structure of customer spending preferences.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including obtaining, over a network from a financial institution and using login credentials of a user, transactions corresponding to the user, calculating average transaction amounts for merchants based on the transactions, generating a spending propensity score for a category using a harmonic mean of amounts in a subset of the transactions corresponding to the category, generating, for the category, spending match scores between the spending propensity score and the average transaction amounts for the merchants, and recommending a merchant to the user using the spending match scores.

In general, in one aspect, one or more embodiments relate to a system including a memory coupled to a computer processor, a repository configured to store transactions corresponding to one or more users, and a recommendation engine executing on the computer processor and using the memory, configured to calculate average transaction amounts for merchants based on the transactions, generate a spending propensity score for a category using a harmonic mean of amounts in a subset of the transactions corresponding to the category and a user, generate, for the category, spending match scores between the spending propensity score and the average transaction amounts for the merchants, and recommend a merchant to the user using the spending match scores.

In general, in one aspect, one or more embodiments relate to a method including obtaining, via a graphical user interface (GUI), transactions corresponding to a user, and sending a subset of the transactions to a recommendation engine. The recommendation engine calculates average transaction amounts for merchants based on the transactions, generates a spending propensity score for a category using a harmonic mean of amounts in a subset of the transactions corresponding to the category, generates, for the category, spending match scores between the spending propensity score and the average transaction amounts for the merchants, and recommends a merchant using the spending match scores. The method further includes receiving, via the GUI, a recommendation of the merchant, displaying, to the user in an element within the GUI generated by a computer processor, the recommendation of the merchant, and initiating, for the user and via the GUI, an interaction with the merchant.

Other aspects of the invention will be apparent from the following description and the appended claims.

### BRIEF DESCRIPTION OF DRAWINGS

FIG. 1A and FIG. 1B show a system in accordance with one or more embodiments of the invention.

FIG. 2A and FIG. 2B show flowcharts in accordance with one or more embodiments of the invention.

FIG. 3 and FIG. 4 show examples in accordance with one or more embodiments of the invention.

FIG. 5A and FIG. 5B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to recommending a merchant to a user. In one or more embodiments, average transaction amounts for merchants are calculated based on transactions corresponding to the merchants. A spending propensity score may be generated for a category using a harmonic mean of amounts in a subset of transactions corresponding to the category and the user. Examples of categories may be “travel expenses”, “food/dining,” etc. The spending propensity score represents the propensity of the user to spend on transactions in the category, across multiple merchants.

Features corresponding to the merchants may be derived from metadata corresponding to the merchants. An example of a feature for the category “food/dining” may be “organic”. A feature propensity score may be generated for a feature and the category by calculating a frequency of a merchant having the feature being included in the subset of the transactions corresponding to the category and the user. The feature propensity score represents the propensity of the user to value the feature in the context of the category.

Spending match scores between the spending propensity score and the average transaction amounts of the merchants may be generated. The spending match scores measure the extent to which the user's propensity to spend in the category matches the average transaction amounts corresponding to the merchants. Feature match scores may be generated for the category and the merchants based on the feature propensity score and a determination regarding whether the respective merchant has the feature. In one or more embodiments, a merchant is recommended to the user using the spending match scores and/or the feature match scores. In other words, the recommended merchant may be the merchant that best matches the user's propensity to spend in the category and/or the user's propensity toward specific features related to the category. For example, the user may have a propensity for expensive transactions in the “travel expenses” category and inexpensive transactions in the “food/dining” category.

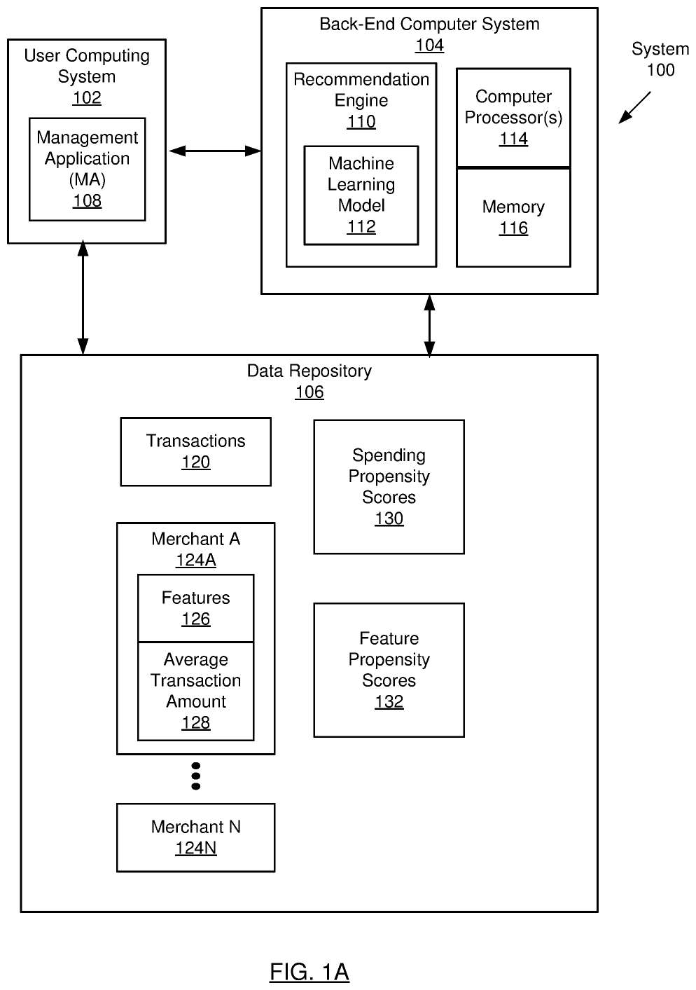

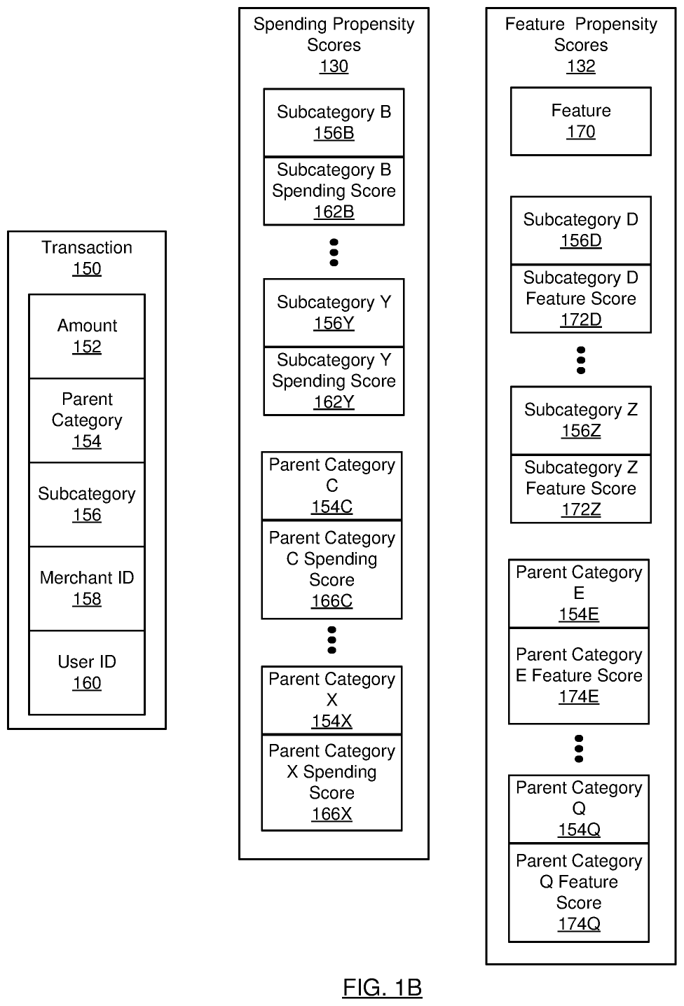

FIG. 1A shows a flow diagram of a system (100) in accordance with one or more embodiments. As shown in FIG. 1A, the system (100) includes multiple components such as the user computing system (102), a back-end computing system (104), and a data repository (106). Each of these components is described below.

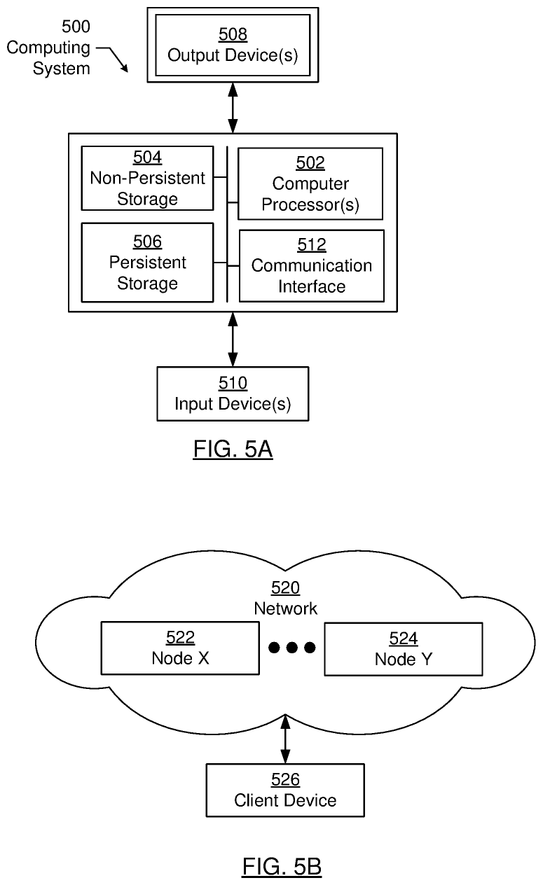

In one or more embodiments, the user computing system (102) provides, to a user, a variety of computing functionality. For example, the computing functionality may include word processing, multimedia processing, financial management, business management, social network connectivity, network management, and/or various other functions that a computing device performs for a user. The user may be a company employee that acts as a sender, a potential sender, or a requestor of services performed by a company (e.g., a client, a customer, etc.) of the user computing system. The user computing system (102) may be a mobile device (e.g., phone, tablet, digital assistant, laptop, etc.) or any other computing device (e.g., desktop, terminal, workstation, etc.) with a computer processor (not shown) and memory (not shown) capable of running computer software. The user computer system (102) may take the form of the computing system (500) shown in FIG. 5A connected to a network (520) as shown in FIG. 5B.

The user computing system (102) includes a management application (MA) (108) in accordance with one or more embodiments. The MA (108), in accordance with one or more embodiments, is a software application written in any programming language that includes executable instructions stored in some sort of memory. The instructions, when executed by one or more processors, enable a device to perform the functions described in accordance with one or more embodiments. In one or more embodiments, the MA (108) is capable of assisting a user with the user's finances or business needs. For example, the MA (108) may be any type of financially-based application such as a tax program, a personal budgeting program, a small business financial program, or any other type of program that assists with finances.

The MA (108) may include a user interface (UI) (not shown) for receiving input from a user and transmitting output to the user. For example, the UI may be a graphical user interface or other user interface. The UI may be rendered and displayed within a local desktop software application or the UI may be generated by a remote web server and transmitted to a user's web browser executing locally on a desktop or mobile device. For example, the UI may be an interface of a software application providing the functionality to the user (e.g., a local gaming application, a word processing application, a financial management application, network management application, business management application etc.). In such a scenario, the help menu, popup window, frame, or other portion of the UI may connect to the MA (108) and present output.

Continuing with FIG. 1A, the data repository (106) is any type of storage unit and/or device (e.g., a file system, database, collection of tables, or any other storage mechanism) for storing data. Further, the data repository (106) may include multiple different storage units and/or devices. The multiple different storage units and/or devices may or may not be of the same type or located at the same physical site. The data repository (106) may be accessed online via a cloud service (e.g., Amazon Web Services, Egnyte, Azure, etc.).

In one or more embodiments, the data repository (106) includes functionality to store transactions (120), merchants (124A, 124N), spending propensity scores (130), and feature propensity scores (132). Each of transactions (120) may be a record of an event involving a merchant (124A) and a user. For example, a transaction may record a purchase by a user from a merchant (124A). In one or more embodiments, a merchant (124A) may correspond to features (126) and an average transaction amount (128). Each of the features (126) may describe a property of the corresponding merchant (124A). For example, a feature may describe a type of product or service, such as organic food, or amenities offered at a hotel, such as a swimming pool or parking facility. Other examples of features (126) may include: a brand name of the corresponding merchant (124A), a geographic location of the corresponding merchant (124A), etc. In one or more embodiments, the average transaction amount (128) may be an average amount (e.g., amount (152) of FIG. 1B) calculated from transactions (120) involving the merchant (124A) (e.g., transactions (120) that include a merchant ID (158) corresponding to the merchant (124A)).

Turning to FIG. 1B, in one or more embodiments, a transaction (150) includes: an amount (152), a parent category (154), a subcategory (156), a merchant ID (158), and a user ID (160). The amount (152) may be a quantity exchanged between the merchant (124A) and the user. For example, the amount (152) may be a dollar amount of money charged by the merchant (124A) to the user. The merchant ID (158) may be an identifier (e.g., a unique identifier) corresponding to the merchant (124A). For example, the merchant ID (158) may be a name, alphanumeric string, a corporate address, or any combination of identifiers of the merchant. Similarly, the user ID (160) may be an identifier corresponding to the user. In one or more embodiments, a parent category (154) is a generally recognized or accepted label that describes a transaction (150), such as, for example, “food & dining,” “travel expenses,” “apparel,” “personal care,” “home improvement,” etc. A subcategory (156) may include any label that adds further detail to the parent category (154), such as, for example, “restaurants,” and “grocery stores,” within the parent category “food & dining,” or “hotels,” “rental cars,” and “flights” within the parent category “travel expenses,” etc.

In one or more embodiments, the spending propensity scores (130) represent the spending behavior of a user. In other words, the spending propensity scores (130) may represent a propensity of a user to engage in transactions involving a high amount (152). As shown in FIG. 1B, the spending propensity scores (130) may be grouped into subcategory spending scores (162B, 162Y) corresponding to subcategories (156B, 156Y) and parent category spending scores (166C, 166X) corresponding to parent categories (154C, 154X). For example, a subcategory spending score for the subcategory “rental car” of the parent category “travel expenses” may be low, indicating that the user has a propensity for inexpensive rental cars. Continuing this example, a subcategory spending score for the subcategory “flights” of the parent category “travel expenses” may be high, indicating that the user has a propensity for expensive flights. The parent category spending score for the parent category “travel expenses” may be a weighted average of the subcategory spending scores corresponding to the subcategories of the parent category “travel expenses.” The weights used to combine the spending propensity scores for the subcategories into the spending propensity score for the parent category may be learned by a machine learning model (e.g., machine learning model (112)).

In one or more embodiments, the feature propensity scores (132) represent the propensity of the user to value a specific feature. The feature propensity scores (132) may represent the propensity of the user to engage in transactions with merchants (124A, 124N) corresponding to the specific feature. For example, the feature propensity scores (132) may represent a frequency with which a user engages in transactions with merchants corresponding to a specific feature. As shown in FIG. 1B, the feature propensity scores (132) for a feature (170) may be grouped into subcategory feature scores (172D, 172Z) corresponding to subcategories (156D, 156Z) and parent category feature scores (174E, 174Q) corresponding to parent categories (154E, 154Q). For example, a subcategory feature score for the feature “organic” and the subcategory “grocery stores” of the parent category “food/dining” may be high, indicating that the user has a propensity to purchase organic food products. Continuing this example, a subcategory feature score for the subcategory “restaurants” of the parent category “food/dining” may be low, indicating that the user does not exhibit a propensity to dine at restaurants serving organic food (e.g., due to the inconvenience of locating such restaurants). Further continuing this example, the parent category feature score for the feature “organic” and the parent category “food & dining” may be a weighted average or weighted mean of the subcategory feature scores corresponding to the subcategories of the parent category “food & dining”.

Returning to FIG. 1A, the back-end computing system (104) may include a recommendation engine (110), computer processor(s) (114), and memory (116). The recommendation engine (110) may include functionality to calculate average transaction amounts (128) for merchants (124A, 124N) using transactions (120) corresponding to the merchants (124A, 124N). The recommendation engine (110) may include functionality to generate spending propensity scores (130) and/or feature propensity scores (132) using a subset of transactions (120) corresponding to a user. In one or more embodiments, the recommendation engine (106) includes functionality to generate spending match scores between a spending propensity score (130) and average transaction amounts (128) of merchants (124A, 124N). The recommendation engine (106) may further include functionality to generate feature match scores between a feature propensity score (132) and the features (126) of merchants (124A, 124N). The recommendation engine (106) may include functionality to combine the spending match score and the feature match score for a merchant (124A). For example, the machine learning model (112) may combine the spending match score and the feature match score using a weighted average. Continuing this example, the weights used to combine the spending match score and the feature match score may be set by a policy (e.g., a rule).

In one or more embodiments, the recommendation engine (106) includes functionality to apply a machine learning model (112) to generate the spending match scores between a spending propensity score (130) and average transaction amounts (128) of merchants (124A, 124N). The recommendation engine (106) may further include functionality to apply the machine learning model (112) to generate the feature match scores between a feature propensity score (132) and the features (126) of merchants (124A, 124N). The recommendation engine (106) may include functionality to apply the machine learning model (112) to combine the spending match score and the feature match score for a merchant (124A). For example, the machine learning model (112) may learn, from training data, a nonlinear function to combine the spending match score and the feature match score. In one or more embodiments, the inputs to the machine learning model (112) (e.g., the transactions (120) and/or the features (126) of merchants (124A, 124N)) are concatenated into a single large vector for processing within the machine learning model (112).

In one or more embodiments, the machine learning model (112) is trained using historical transactions and/or features of merchants, and recommendations labeled “successful” when the user initiated a new transaction with the recommended merchant, and labeled “unsuccessful” when the user did not initiate a new transaction with the recommended merchant. The machine learning model (112) may thus be trained to learn how to correlate the success or failure of a recommendation with spending match scores and/or feature match scores corresponding to merchants (124A, 124N).

The machine learning model (112) may be implemented as a classifier. For example, the machine learning model (112) may classify a merchant (124A) as a best recommendation for a user relative to a subcategory (156) or parent category (154). The machine learning model (112) may be implemented as various types of deep learning classifiers such as a neural network classifier (e.g., based on convolutional neural networks (CNNs)), random forest classifier, stochastic gradient descent (SGD) classifier, lasso classifier, gradient boosting classifier, bagging classifier, adaptive boosting (AdaBoost) classifier, ridge classifier, elastic net classifier, or Nu Support Vector Regression (NuSVR) classifier. Deep learning, also known as deep structured learning or hierarchical learning, is part of a broader family of machine learning methods based on learning data representations, as opposed to task-specific algorithms.

In one or more embodiments, the computer processor(s) (114) takes the form of the computer processor(s) (502) described with respect to FIG. 5A and the accompanying description below. In one or more embodiments, the memory (116) takes the form of the non-persistent storage (504) and/or persistent storage (506) described with respect to FIG. 5A and the accompanying description below.

While FIG. 1A and FIG. 1B show a configuration of components, other configurations may be used without departing from the scope of the invention. For example, various components may be combined to create a single component. As another example, the functionality performed by a single component may be performed by two or more components.

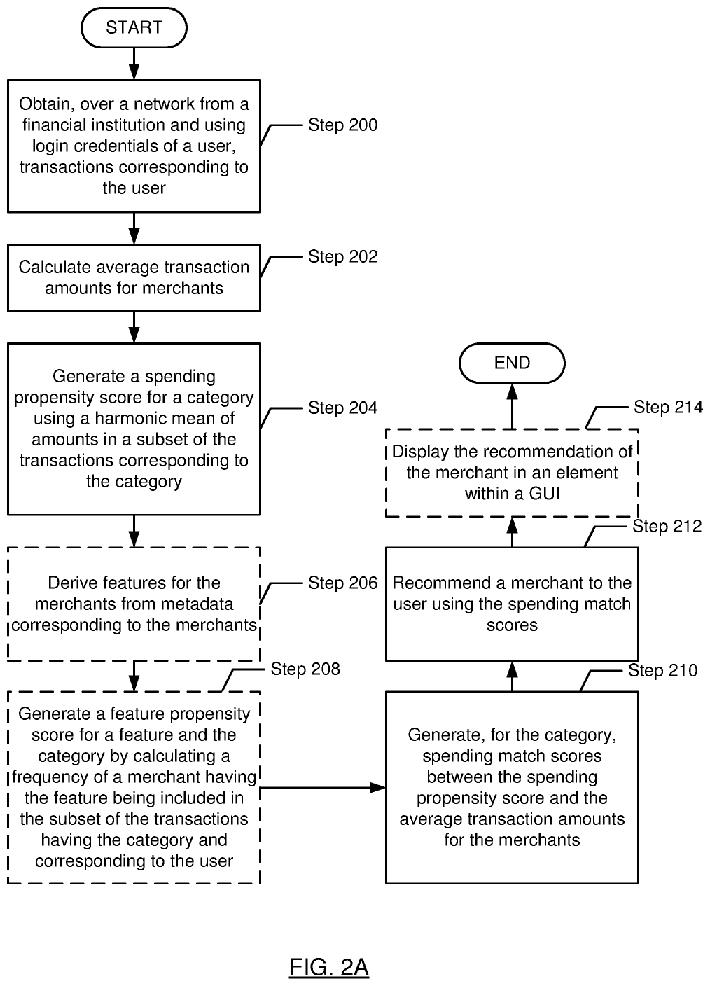

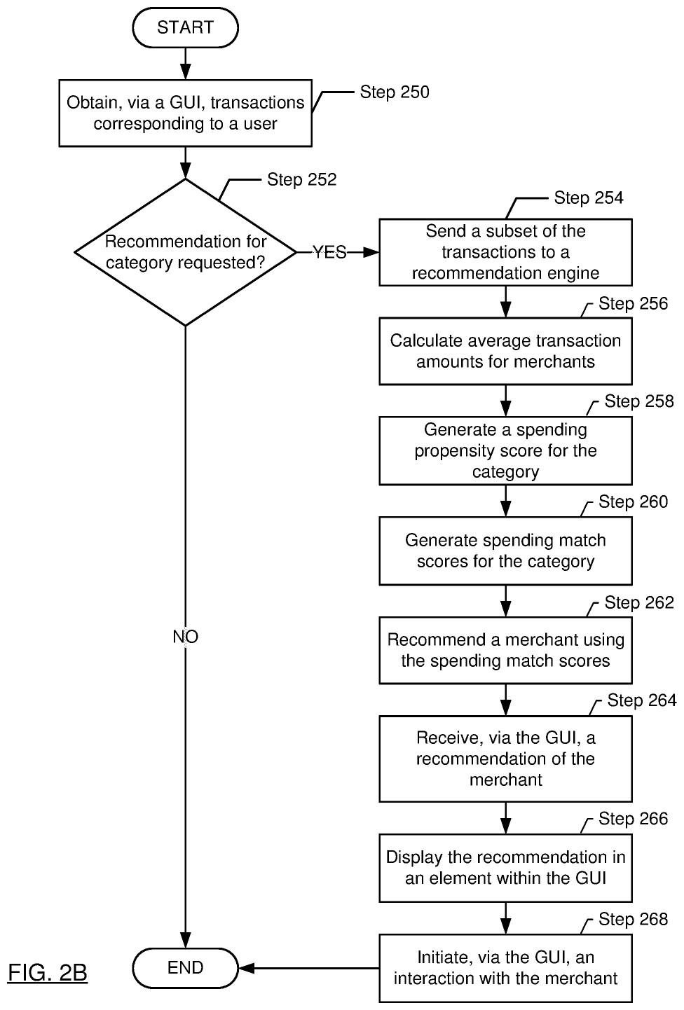

FIG. 2A shows a flowchart in accordance with one or more embodiments of the invention. The flowchart depicts a process for generating a recommendation. One or more of the steps in FIG. 2A may be performed by the components (e.g., the recommendation engine (106) of the back-end computing system (104) and the user computing system (102)), discussed above in reference to FIG. 1A. In one or more embodiments of the invention, one or more of the steps shown in FIG. 2A may be omitted, repeated, and/or performed in parallel, or in a different order than the order shown in FIG. 2A. Accordingly, the scope of the invention should not be considered limited to the specific arrangement of steps shown in FIG. 2A.

Initially, in Step 200, transactions corresponding to a user are obtained, over a network from a financial institution using login credentials of the user. For example, the financial institution may be a bank or a credit card processing company. In one or more embodiments, the transactions correspond to a single user (e.g., a user of a management application). Alternatively, the transactions may correspond to multiple users. The transactions may be obtained from multiple financial institutions.

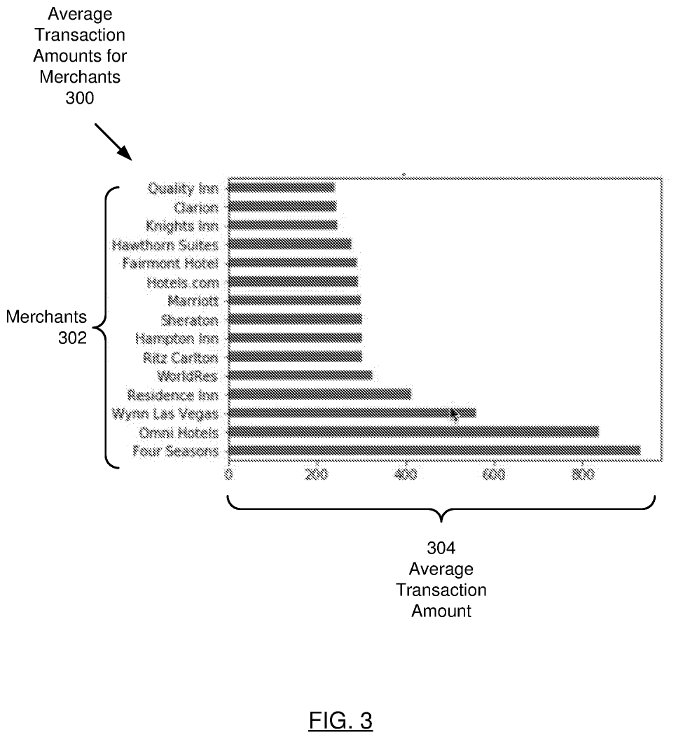

In Step 202, average transaction amounts for merchants are calculated based on transactions corresponding to the merchants. The average transaction amount for each merchant is a measure by which the merchants may be compared. For example, the average transaction amount for a merchant may be thought of as a “charging propensity score” of the merchant that is matched to a spending propensity score of a user in Step 210 below. FIG. 3 shows an example of average transaction amounts for merchants (300) where the merchants (302) are hotels and the average transaction amount (304) is the dollar amount charged per night.

In Step 204, a spending propensity score is generated for a category using a harmonic mean of amounts in a subset of the transactions corresponding to the category and corresponding to a user. For example, the harmonic mean may be used to smooth the impact of outlier or anomalous data points (e.g., transaction amounts resulting from discounts). Alternatively, a geometric mean may be used to generate the spending propensity score. The spending propensity score represents the spending propensity of the user in the category, across multiple merchants.

In one or more embodiments, the category is a parent category (e.g., food & dining). Alternatively, the category may be a subcategory (e.g., restaurants) of a parent category. In one or more embodiments, the recommendation engine generates the spending propensity score for a parent category using the spending propensity scores for one or more subcategories of the category. For example, the recommendation engine may generate the spending propensity score for a parent category by combining the spending propensity scores for two or more subcategories of the category. Continuing this example, the spending propensity scores for the subcategories may be combined using a weighted average (e.g., where the weights used to combine the spending propensity scores for the subcategories may be learned by a trained machine learning model).

In Step 206, features corresponding to the merchants are derived from metadata corresponding to the merchants. In one or more embodiments, the recommendation engine derives features corresponding to metadata obtained by querying a merchant database using the merchant ID corresponding to each merchant. For example, the merchant database may be a commercial business directory or a public resource (e.g., Wikipedia). The derived features may correspond to keywords and/or attributes extracted from the merchant database corresponding to the merchant ID of a merchant. For example, the merchant database may include information about the merchant, such as a listing of products and/or services offered by the merchant, where each listing includes one or more keywords describing the product or service. Continuing this example, the merchant database may further include values for one or more attributes of the merchant, such as geographic location, hours of operation, brand name, etc.

In Step 208, a feature propensity score is generated for a feature and the category by calculating a frequency of a merchant having the feature being included in the subset of the transactions having the category and corresponding to the user (see description of Step 204 above). For example, the frequency of a merchant having the feature being included in the subset of the transactions having the category and corresponding to the user may represent a probability that the user engages in transactions with merchants corresponding to the feature. In one or more embodiments, the recommendation engine generates the feature propensity score for a parent category using the feature propensity scores for one or more subcategories of the category. For example, the recommendation engine may generate the feature propensity score for a parent category by combining the feature propensity scores for two or more subcategories of the category. Continuing this example, the feature propensity scores for the subcategories may be combined using a weighted average (e.g., where the weights used to combine the feature propensity scores for the subcategories may be learned by a trained machine learning model).

In Step 210, spending match scores between the spending propensity score and the average transaction amounts of the merchants are generated for the category. In one or more embodiments, the recommendation engine converts the spending propensity score and the average transaction amounts to a common scale before generating the spending match scores. For example, the recommendation engine may use various normalization techniques to perform the conversion of the spending propensity score and the average transaction amounts to a common scale. In one or more embodiments, the recommendation engine calculates each spending match score using the difference between the converted spending propensity score and the converted average transaction amount.

For example, the spending match scores may be normalized to a scale ranging from 0 to 1, where a spending match score of 1 corresponds to no difference between the converted spending propensity score and the converted average transaction amount (i.e., an exact match). Continuing this example, spending match scores less than 1 may be inversely proportional to the difference between the converted spending propensity score and the converted average transaction amount.

In one or more embodiments, feature match scores are generated for the category and the merchants based on the feature propensity score and a determination regarding whether the respective merchant has the feature. In one or more embodiments, the recommendation engine determines whether the merchant has the feature using the features derived for the merchant in Step 206 above. The determination may be a binary determination. For example, the recommendation engine may determine that the merchant either has the feature or that the merchant does not have the feature. Continuing this example, when the determination is a binary determination, the recommendation engine generates the feature match score for a merchant by multiplying the feature propensity score by one, when the merchant has the feature, or by zero, when the merchant does not have the feature.

Alternatively, the determination may be an estimate that the merchant has the feature. For example, although the merchant may not explicitly have the feature, the recommendation engine may determine, using a feature similarity measure, that the merchant has a similar feature. Continuing this example, the feature similarity measure may be based on representing the features as vectors in a semantic space (e.g., a word2vec semantic space). For example, the features “organic” and “gluten free” may be similar features in a semantic space because both features relate to health concerns. The feature similarity measure may be normalized to a scale ranging from 0 to 1. When the determination is an estimate, the recommendation engine may generate the feature match score for a merchant by multiplying the feature propensity score by the feature similarity measure.

In Step 212, a merchant is recommended to the user using the spending match scores. In one or more embodiments, the recommendation engine recommends the merchant corresponding to the spending match score that corresponds to the average transaction amount that best matches the spending propensity score. For example, the average transaction amount that best matches the spending propensity score may be the average transaction amount that corresponds to the converted average transaction amount that is closest to the converted spending propensity score.

In one or more embodiments, the merchant is recommended to the user using both the spending match scores and the feature match scores (see description of Step 210 above). The recommendation engine may combine the spending match score and the feature match score for each merchant into a combined match score. For example, the recommendation engine may combine the spending match score and the feature match score for the merchant using a weighted average. The weights used to combine the spending match score and the feature match score may be learned by a trained machine learning model. Alternatively, the recommendation engine may apply a machine learning model to combine (e.g., via a nonlinear function) the spending match score and the feature match score for a merchant.

In Step 214, the recommendation of the merchant is displayed to the user via an element within a graphical user interface (GUI). In one or more embodiments, the element (e.g., a widget) is generated by a computer processor and rendered within the GUI. In one or more embodiments, the recommendation engine initiates an interaction with the merchant on behalf of the user via the GUI. For example, the recommendation engine may display, in the GUI, a link to a web site of the merchant where the user may initiate a transaction with the merchant (e.g., where the user may purchase and/or browse products and/or services offered by the merchant).

In one or more embodiments, the recommendation engine may receive, in response to displaying the recommendation of the merchant to the user via the GUI, a notification of a new transaction initiated by the user with the merchant. In response to receiving the notification of the new transaction, the recommendation engine may update the spending propensity score for the category using the amount of the new transaction. In other words, the recommendation engine may update a spending propensity score corresponding to the user as new transactions are received. In this way, the spending propensity score may accurately reflect the most up-to-date spending propensity of the user. Similarly, in response to receiving the notification of the new transaction, the recommendation engine may update the feature propensity score for the category based on whether the new transaction corresponds to a merchant that has the feature.

In one or more embodiments, the recommendation engine generates an explanation for recommending the merchant to the user. For example, the explanation may include the average transaction amount of the merchant. The recommendation engine may display the explanation to the user via the GUI. If the recommendation engine determines in Step 210 above that the recommended merchant has the feature, then the explanation may include the feature. Alternatively, if the recommendation engine determines in Step 210 above that the recommended merchant has a similar feature, then the explanation may include the feature and the similar feature.

FIG. 2B shows a flowchart in accordance with one or more embodiments of the invention. The flowchart depicts a process for generating a recommendation. One or more of the steps in FIG. 2B may be performed by the components (e.g., the recommendation engine (106) of the back-end computing system (104) and the user computing system (102)), discussed above in reference to FIG. 1A. In one or more embodiments of the invention, one or more of the steps shown in FIG. 2B may be omitted, repeated, and/or performed in parallel, or in a different order than the order shown in FIG. 2B. Accordingly, the scope of the invention should not be considered limited to the specific arrangement of steps shown in FIG. 2B.

Initially, in Step 250, transactions corresponding to a user are obtained via a graphical user interface (GUI). For example, the transactions may be entered into the GUI by a user of the management application.

If, in Step 252, it is determined that a recommendation has been requested for a category, then Step 254, Step 256, Step 258, Step 260, Step 262, Step 264, Step 266, and Step 268 below are executed.

In Step 254, a subset of the transactions are sent to the recommendation engine. The subset of the transactions may correspond to the category. The subset of the transactions may be sent to the recommendation engine by the management application over a network.

In Step 256, average transaction amounts for merchants are calculated based on transactions corresponding to the merchants (see description of Step 202 above).

In Step 258, a spending propensity score is generated for the category (see description of Step 204 above).

In Step 260, spending match scores are generated for the category (see description of Step 210 above).

In Step 262, a merchant is recommended using the spending match scores (see description of Step 212 above).

In Step 264, the recommendation of the merchant is received by the GUI. In one or more embodiments, the recommendation is sent, over the network, by the recommendation engine to the user computing system.

In Step 266, the recommendation of the merchant is displayed via an element within the GUI (see description of Step 214 above).

In Step 268, an interaction with the recommended merchant is initiated on behalf of the user via the GUI (see description of Step 214 above).

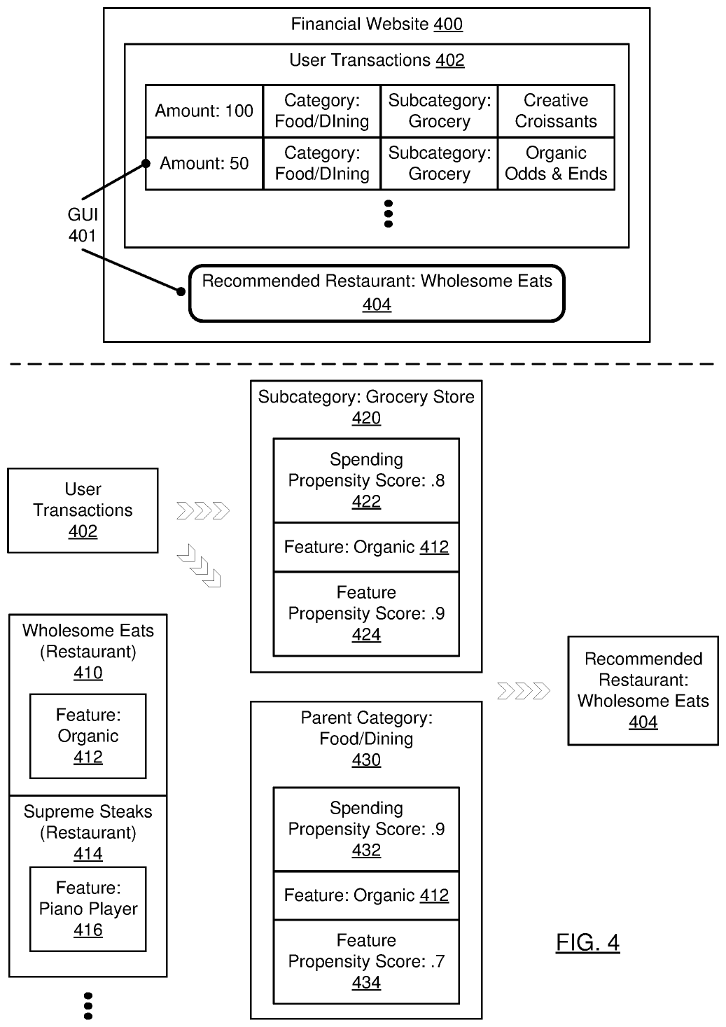

The following example is for explanatory purposes only and not intended to limit the scope of the invention. FIG. 4 shows an implementation example in accordance with one or more embodiments of the invention. FIG. 4 shows a financial website (400) executing a recommendation engine. The recommendation engine obtains user transactions (402) (e.g., (120) in FIG. 1A and (150) in FIG. 1B) entered by a user via a graphical user interface (GUI) (401) (e.g., a GUI of the management application (108) of FIG. 1A) of a user computing system that communicates with the financial website (400) over a network. The recommendation engine calculates average transaction amounts for merchants (e.g., Wholesome Eats (410) and Supreme Steaks (414)) ((124A, 124N) in FIG. 1A) based on transactions corresponding to various users. In this case, the average transaction amount for Wholesome Eats (410) is $25 and the average transaction amount for Supreme Steaks (414)) is $45.

The user requests, via the GUI (401), a recommendation for a merchant in the subcategory “restaurant”, which corresponds to the parent category “food/dining” (430) ((154) in FIG. 1B). The recommendation engine cannot generate a spending propensity score for the user and the subcategory “restaurant” because the user has not yet entered transactions corresponding to the subcategory “restaurant”. However, the recommendation engine generates a spending propensity score (422) ((162B, 162Y) in FIG. 1B) of 0.8 for the user and the subcategory “grocery store” (420) ((156) in FIG. 1B) based on the user's transactions corresponding to the subcategory “grocery store” (420). The subcategory grocery store” (420), like the subcategory “restaurant”, also corresponds to the parent category “food/dining” (430). The recommendation engine also generates a feature propensity score (424) ((172D, 172Z) in FIG. 1B) of 0.9 for the feature “organic” (412) ((126) in FIG. 1A and (170) in FIG. 1B) in the subcategory “grocery store” (420) based on the user's transactions corresponding to the subcategory “grocery store” (420) and the features of the merchants corresponding to the user's transactions in the subcategory “grocery store” (420).

In addition, the recommendation engine generates a spending propensity score (432) of 0.9 and a feature propensity score (434) of 0.7 for the feature “organic” (412) for the user and the parent category “food/dining” (430) based on the user's transactions corresponding to the parent category “food/dining” (430). The user's transactions corresponding to the parent category “food/dining” (430) includes transactions corresponding to additional subcategories of the parent category “food/dining” (430) besides the subcategory “grocery store” (420) (e.g., subcategories “café”, “juice bar”, etc.).

The recommendation engine then generates spending match scores and feature match scores for various merchants corresponding to the subcategory “restaurant” using the spending propensity score (432) and the feature propensity score (434) of the parent category “food/dining” (430). The spending match score generated for Wholesome Eats (410) is 0.5 (e.g., the match is not close because the user generally spends more on transactions than the average transaction amount corresponding to Wholesome Eats (410)). The feature match score for Wholesome Eats (410) is 0.9 which is the same as the feature propensity score (434) of 0.9 for the parent category “food/dining” (430) and the feature “organic” (412) because the recommendation engine determines that Wholesome Eats (410) does in fact correspond to the feature “organic” (412). The recommendation engine equally weights the spending match score and the feature match score to generate a combined match score of 1.4 for Wholesome Eats (410).

The spending match score for Supreme Steaks (414) is 0.9 (e.g., because the average transaction amount corresponding to Supreme Steaks (414) is a strong match relative to the user's spending propensity score). The feature match score for Supreme Steaks (414) is zero because the recommendation engine determines that Supreme Steaks (414) does not correspond to the feature “organic” (412). Although Supreme Steaks (414) does correspond to the feature “piano player” (416), the user has no propensity for the feature “piano player” (416), based on the user's transactions corresponding to the parent category “food/dining” (430). The recommendation engine then equally weights the spending match score and the feature match score to generate a combined match score of 0.9 for Supreme Steaks (414). The combined match score for Wholesome Eats (410) is the highest, so the recommendation engine recommends Wholesome Eats (410) to the user as a merchant in the subcategory “restaurant”. Although Wholesome Eats (410) is a less expensive restaurant than Supreme Steaks (414), Wholesome Eats (410) has the “organic” feature (412) that is strongly valued by the user in the parent category “food/dining” (430). Thus, the recommendation may save money for the user while simultaneously satisfying an important value of the user.

The GUI (401) then receives the recommendation of the merchant Wholesome Eats (410) from the recommendation engine. The GUI (401) displays the recommendation to the user with a link to the website of Wholesome Eats (410) so that the user may make a dinner reservation, browse a menu, etc.

Embodiments of the invention may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments of the invention.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 5A and the nodes and/or client device in FIG. 5B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
obtaining, over a network from a financial institution and using login credentials of a user, transactions corresponding to the user;
calculating a plurality of average transaction amounts for a plurality of merchants based on the transactions;
generating a spending propensity score for a category using a harmonic mean of amounts in a subset of the transactions corresponding to the category;
generating, for the category, a plurality of spending match scores between the spending propensity score and the average transaction amounts for the plurality of merchants; and
recommending a merchant of the plurality of merchants to the user using the plurality of spending match scores.

2. The method of claim 1, wherein the plurality of merchants each correspond to one or more features of a plurality of features, the method further comprising:
generating, for a feature of the plurality of features, a feature propensity score for the category by calculating a frequency of a merchant having the feature being included in the subset of the transactions having the category and corresponding to the user; and
generating, for the category and the plurality of merchants, a plurality of feature match scores based on the feature propensity score and a determination regarding whether the respective merchant has the feature,
wherein recommending the merchant further uses the plurality of feature match scores.

3. The method of claim 2, further comprising:
deriving the one or more features corresponding to the merchant from metadata corresponding to the merchant.

4. The method of claim 2, further comprising:
generating an explanation for recommending the merchant to the user, wherein the explanation comprises the feature.

5. The method of claim 2, wherein the plurality of feature match scores is generated by a trained machine learning model.

6. The method of claim 1, further comprising:
displaying, to the user in an element within a graphical user interface (GUI) generated by a computer processor, the recommendation of the merchant; and
initiating, for the user and via the GUI, an interaction with the merchant.

7. The method of claim 6, further comprising:
receiving, from the user, via the GUI, and in response to recommending the merchant, a notification of a new transaction having the category; and
updating, using the new transaction, the spending propensity score for the category.

8. A system, comprising:
a memory coupled to a computer processor;
a repository configured to store transactions corresponding to one or more users; and
a recommendation engine, executing on the computer processor and using the memory, configured to:
calculate a plurality of average transaction amounts for a plurality of merchants based on the transactions,
generate a spending propensity score for a category using a harmonic mean of amounts in a subset of the transactions corresponding to the category and a user of the one or more users,
generate, for the category, a plurality of spending match scores between the spending propensity score and the average transaction amounts for the plurality of merchants, and
recommend a merchant of the plurality of merchants to the user using the plurality of spending match scores.

9. The system of claim 8, wherein the plurality of merchants each correspond to one or more features of a plurality of features, and wherein the recommendation engine is further configured to:
generate, for a feature of the plurality of features, a feature propensity score for the category by calculating a frequency of a merchant having the feature being included in the subset of the transactions having the category and corresponding to the user, and
generate, for the category and the plurality of merchants, a plurality of feature match scores based on the feature propensity score and a determination regarding whether the respective merchant has the feature,
wherein recommending the merchant further uses the plurality of feature match scores.

10. The system of claim 9, wherein the recommendation engine is further configured to:
derive the one or more features corresponding to the merchant from metadata corresponding to the merchant.

11. The system of claim 9, wherein the recommendation engine is further configured to:
generate an explanation for recommending the merchant to the user, wherein the explanation comprises the feature.

12. The system of claim 9, further comprising a trained machine learning model, wherein the feature match scores is generated by the trained machine learning model.

13. The system of claim 8, further comprising a graphical user interface (GUI) configured to:
display, to the user in an element within the GUI generated by a computer processor, the recommendation of the merchant, and
initiate, for the user, an interaction with the merchant.

14. The system of claim 13,
wherein the GUI is further configured to receive, from the user and in response to recommending the merchant, a notification of a new transaction having the category, and
wherein the recommendation engine is further configured to update, using the new transaction, the spending propensity score for the category.

15. A method comprising:
obtaining, via a graphical user interface (GUI), transactions corresponding to a user;
sending a subset of the transactions to a recommendation engine, wherein the recommendation engine:
calculates a plurality of average transaction amounts for a plurality of merchants based on the transactions;
generates a spending propensity score for a category using a harmonic mean of amounts in the subset of the transactions corresponding to the category;
generates, for the category, a plurality of spending match scores between the spending propensity score and the average transaction amounts for the plurality of merchants; and
recommends a merchant of the plurality of merchants using the plurality of spending match scores;
receiving, via the GUI, a recommendation of the merchant;
displaying, to the user in an element within the GUI generated by a computer processor, the recommendation of the merchant; and
initiating, for the user and via the GUI, an interaction with the merchant.

16. The method of claim 15, further comprising:
determining that a recommendation has been requested for the category, wherein the subset of the transactions sent to the recommendation engine correspond to the category.

17. The method of claim 15, wherein the plurality of merchants each correspond to one or more features of a plurality of features, and wherein the recommendation engine is further configured to:
generate, for a feature of the plurality of features, a feature propensity score for the category by calculating a frequency of a merchant having the feature being included in the subset of the transactions having the category and corresponding to the user; and
generate, for the category and the plurality of merchants, a plurality of feature match scores based on the feature propensity score and a determination regarding whether the respective merchant has the feature,
wherein recommending the merchant further uses the plurality of feature match scores.

18. The method of claim 17, wherein the recommendation engine is further configured to:
derive the one or more features corresponding to the merchant from metadata corresponding to the merchant.

19. The method of claim 17, wherein the recommendation engine is further configured to:
generate an explanation for recommending the merchant to the user, wherein the explanation comprises the feature.

20. The method of claim 15, further comprising:
receiving, from the user, via the GUI, and in response to recommending the merchant, a notification of a new transaction having the category; and
sending the new transaction to the recommendation engine, wherein the recommendation engine is further configured to update, using the new transaction, the spending propensity score for the category.
